(19) United States
(12) Patent Application Publication
(10) Pub. No.: US 2008/0212575 A1
(43) Pub. Date: Sep. 4, 2008

(54) Codec Rate Adaptation as a Function of Air-Interface as Wel as Network in a Packet-Based Network

(76) Inventor: Lars Westberg, Enkoping (SE)

Correspondence Address: ERICSSON INC., 6300 LEGACY DRIVE, M/S EVR 1-C-11, PLANO, TX, 75024, US

(21) Appl. No.: 11/916,705

(22) PCT Filed: Jun. 15, 2006
(86) PCT No.: PCT/SE06/50198

§ 371 Date: Mar. 18, 2008

Related U.S. Application Data
(60) Provisional application No. 60/690,688, filed on Jun. 15, 2005.

(51) Int. Cl. H04L 12/66

(52) U.S. Cl. 370/356

(57) ABSTRACT

Codec rate adaptation for wireless circuit-switched voice communications routed through a packet-based network. A Mobile Station (MS) preferably with Circuit Switched services participating in a voice communication with a distant terminal transmits an initial CMR identifying an initial maximum speech coding rate selected as a function of a downlink radio quality. At each intermediate network node, one or more operational parameters are determined by using an Explicit Congestion Notification (ECN) protocol. When a CMR is received at each network node, if the operational parameters are not within a predetermined range suitable for the transmission of speech packets through the network using the initial maximum speech coding rate the maximum speech coding rate identified in the CMR is reduced as a function of the operational parameters and then forwarded toward the distant terminal.

### TECHNICAL FIELD

The invention is related, in general, to voice communications and, in particular, to adaptive transport of mobile telephony voice communications via an Internet Protocol (IP) network.

### BACKGROUND

Recently, Internet Protocol (IP) transport solutions have been considered for 3^{rd} generation (3G) networks because of the flexibility and wide deployment of IP technologies. These networks have different characteristics when compared to traditional IP networks requiring fast dynamic resource reservation, simplicity, low costs, handling of severe congestion and good scalability properties.

The main problem with deployment of Quality of Service (QoS) enabled networks is that many of the applications require rather complex management of the QoS-architecture to achieve good properties. The management is required to ensure that the network does not generate packet loss due to congestion. The major obstacles are that a temporary mismanagement may generate packet loss and poor speech quality for all connections passing the congested link. This is a behavior that is specific for packet networks—Asynchronous Transfer Mode (ATM) and especially for IP. On the other side, the Internet uses performance monitoring based provisioning; e.g. background measurement of delay and packet loss that can in some cases be seen as a simpler management method than more classical provisioning methods. When circuit-switched telephony is transported over an IP-network, a mission critical application is using the transport network. Performance requirements and stability requirements are therefore extremely high and strict performance guarantees are needed.

Another important aspect is the development of adaptive voice coding; e.g. Adaptive Multi-Rate (AMR) is a way to optimize the use of the radio spectrum (bit rate) for circuit-switched voice applications. However, AMR is an adaptive voice codec that can also be used for varying the bit rate needed in the IP-network. If the bit rate of voice codecs can adapt to the load situation in the network, the requirements on the management can be looser. Therefore, the combination of adaptive voice codecs for circuit-switched speech can simplify the management of the IP-network.

The current solution of management of the backbone is based on over-provisioning or static provisioning. Over-provisioning gives low bandwidth utilization but more simple management. However, the required over-provisioning margin depends on many factors:
Time for network re-provisioning; e.g., time for extending the network with more capacity.
Time between monitoring of the network. If the network is monitored more often a possible overload situation can be discovered earlier. If the network is more rarely monitored, the margins have to be higher.
Probability and guarantees for mass-call events. During specific events (accidents, football game, etc.) the traffic matrix will be different from usual.

Another solution is based on static provisioning. The provisioning is based on static profiles, downloaded in a Media Gateway (MGW). The MGW limits the traffic by blocking calls if the MGW can generate more traffic than allowed according to the profile. However, the static provisioning has the following drawbacks:
Resource requirement for management of profiles in MGW. Each time the configuration of the network is changed, some of the profiles have to be changed. This generates a management burden.
Profiles' dependence on the network topology. If the topology is changed, the profiles may also be changed.
The fact that static profiles do not react on temporary change in the network such as link and node failures.

The adaptability is much more convenient, because, in general, the network should adapt to the circumstances rather than require pre-configured knowledge. If a multi-service network is used, some traffic may be adaptive while others will not adapt and this feature can only be applied to the adaptive traffic. Therefore, we may use different traffic classes, e.g. different per-hop behaviors (PHB:s) for different traffic types.

A typical implementation of Voice Over IP (VoIP) (the protocol stack is within the end-system) is illustrated in FIG. 1. This proposal is well known in Internet Engineering Task Force (IETF) to resolve VoIP for Internet. However, a new protocol denoted Datagram Congestion Control Protocol (DCCP) has to been developed (RFC 4340). DCCP is a connection-oriented unreliable protocol for transporting media flows. The protocol also includes congestion control that allows the IP-network to be adapted to the load-situation in the network.

Another component is that IETF has developed a protocol, Explicit Congestion Notification (ECN) for the network to report congestion. The protocol is implemented as two bits (the same as diff.serv.) in the IP-header. The router inside the network sets the bits during high load (due to large buffers inside the network) in the network; see IETF Request for Comments (RFC) 3168, “The Addition of Explicit Congestion Notification (ECN) to IP” (September 2001), incorporated herein by reference. The ECN protocol can be used to signal congestion situations when large buffers are experienced or limited bandwidth inside the network by setting the ECN-bits and before and without causing packet-drop for the media-flows.

The DCCP-protocol is a transport protocol for datagrams, e.g. User Datagram Protocol (UDP) services. The main different to UDP is that DCCP contains congestion control like Transport Control Protocol (TCP). If TCP discovers a dropped packet (or a ECN-marked packet), the TCP-protocol decreases it's packet rate. No such action is made by UDP. UDP sources can continue to send packets without reacting on congestion. The DCCP-protocol is giving the same un-reliable service like UDP, but will react on dropped and ECN-marked packets and decrease its packet rate. The DCCP protocol in the host will then adapt to the congestion situation in the network.

FIG. 2 illustrates the use of DCCP and ECN. Each DCCP connection runs between two hosts. DCCP connections are bidirectional: data may pass from either endpoint to the other. This means that data and acknowledgements may be flowing in both directions simultaneously. An acknowledgement framework lets senders discover how much data has been lost, and thus avoid unfairly congesting the network. When Diff.serv is used Diff.serv remarking is indicating congestion in a similar way.

The congestion control in DCCP is similar to that of TCP. The sender maintains a congestion window and sends packets until that window is full. Received packets are acknowledged by the receiver. Congestion control requires receivers to include in acknowledgements information about packet losses and ECN marks (or Diff.serv remarking).

ECN is marked in a field in the IP protocol header with two bits, making four ECN codepoints, ‘00’ to ‘11’. The not-ECN codepoint ‘00’ indicates a packet that is not using ECN. The ‘11’ is set by a router to indicate congestion to the end nodes. This is indicated in the DCCP protocol through a flag.

The interaction can briefly be described as follows:
1) Receive packet;
2) Check if packet is marked or detect, if a packet is dropped;
3) If marked or dropped=>decrease sending packet rate.
   The relation between marked/dropped packets is controlled by an internal algorithm inside DCCP. Different algorithms can be negotiated during DCCP-session establishment.

FIGS. 3a and 3b illustrate the state-of-the-art in GSM and UMTS cellular networks, respectively. In cellular networks, the Adaptive Multi-Rate codecs (AMR and AMR-WB) adapt to the condition(s) in the air-interface(s). The adaptability is used to optimize the performance in the air interface(s). In Global System for Mobile Communications (GSM), the AMR-codec is located in the Mobile Station (MS) and Base Station Controller (BSC) and the adaptability is based on statistics and on-line measurements from the air-interface in uplink and/or downlink. In Universal Mobile Telecommunications Systems (UMTS), the speech codec is located in the MS (alternatively denoted User Equipment, UE) and Media Gateway (MGW) and the rate is mainly controlled by the Radio Network Controller (RNC) based on cell load.

The adaptability in AMR in GSM is implemented by using AMR Codec Mode Requests (CMR) embedded inside the AMR-payload, flowing in the reverse direction, similar to DCCP, where the receiver tells the transmitter how to send. A number of bits in the AMR-payload sent from the MS to the BTS sets the highest rate the AMR-Encoder in BSC can send with towards the MS. In case of Mobile-to-Mobile calls in transcoding free operation this AMR codec mode request is potentially modified on the way through the network such that the combination of the receiving decoder and receiving air-interface (in downlink) and the sending encoder and sending air interface (in uplink) are equally well considered. This means that the rate-control decision in one direction is the combination of what the receiver wants and the network and air interfaces allow.

The AMR codec Rate Control information, which has to be transmitted on each link in both directions, consists of the Codec Mode Indications (CMI) and Codec Mode Requests (CMR). The Codec Mode Indications (CMI) inform the receiver about the currently applied AMR-codec mode of the received speech payload. The CMI flows with the payload in the same direction The CMR flows in the reverse direction and tells the sender what to use (as maximum bit rate) in the next speech period (see TS 3GPP 45.009).

As an example for the operation for a Mobile-to-PSTN (Public Switched Telephone Network) call, a mobile station A (MS A) sends a speech frame in uplink. This speech frame includes a maximum rate command (included in CMR) that the mobile station A wants to receive compressed speech in downlink in the next period. This rate control (in the speech payload) is forwarded to the Base Transceiver Station (BTS A) and then to BSC A, where the encoder is (typically) situated. The rate in downlink is further decreased if the air-interface is heavily loaded or affected by poor air-interface conditions, in which case MS A sends further Codec Mode Requests for lower bit rates.

In a GSM network a Mobile-to-Mobile call involving two BSCs (BSC A and BSC B), the Codec Mode Request is sent further on by BSC A to the far end BSC B, then to BTS B and finally to the far end mobile station B, where the encoder is situated in this end-to-end transcoding free mobile-to-mobile call. Potentially, the CMR is modified by BTS A, BSC A and/or BSC B and BTS B on the way from the near end mobile station A to the far end mobile station B to take into account not only the requirements by the downlink to the near end mobile station A, but also the requirements by the uplink from the far end mobile station B. The original CMR is therefore issued by the final receiver, the near end mobile station A, but a potential modification of this rate-control command in the speech payload is therefore made by intermediate nodes such as the BSCs and BTSs. All these nodes in the path are allowed to lower the maximum rate request, none is allowed to increase the rate request.

In the UMTS radio interface, the speech payload is sent by the User Equipment A (UE A) transparently (i.e. without Codec Mode Request) to the MGW, but the radio network controller A (RNC A) sends rate control requests in parallel to the speech payload. Both, speech and the appended rate control request, are sent uplink to the transcoder in the MGW A. In case of end-to-end transcoding free mobile-to-mobile calls these Rate Control Requests are further send by MGW A to MGW B and then downlink to RNC B and UE B, very similar to the handling in GSM. Seamless Interworking between the Codec Mode Request in GSM and the Rate Control Request in UMTS is defined.

In summary of the prior art: the Rate Control defined by 3GPP for GSM and UMTS allows to take the radio congestions of both radio links into account, but it does not define how to consider capacity bottlenecks in the transport network between the radio interfaces. The congestion control defined by IETF does not consider the radio interfaces.

### SUMMARY

To overcome the deficiencies of the prior art, the invention disclosed herein provides coder/decoder (codec) rate adaptation for wireless circuit-switched voice communications routed through an internet protocol network, such as e.g. the Internet. A Mobile Station (MS) participating in a voice communication with a distant terminal, which can be another MS, transmits an initial Codec Mode Request (CMR) identifying an initial maximum speech coding rate selected as a function of its local downlink radio quality. At each intermediate network node in the packet-based network, one or more operational parameters are determined by using Explicit Congestion Notification (ECN) protocol or diff.serv remarking; the ECN protocol can, for example, report network characteristics such as congestion in the packet-based network based on speech packets transmitted by the distant terminal to the mobile station. When a Codec Mode Request is received at each network node, if the operational parameters are not within a predetermined range suitable for the transmission of speech packets through the network using the initial maximum speech coding rate, the maximum speech coding rate identified in the Codec Mode Request is reduced as a function of the operational parameters and then the modified Codec Mode Request is forwarded toward the distant terminal.

The Codec Mode Request can be further modified at a second (i.e., subsequent) intermediate node. In such cases, one or more operational parameters of the packet-based network are determined at such subsequent network node using the ECN protocol or diff.serv remarking or other methods. When the modified Codec Mode Request is received at a subsequent network node, if the operational parameters are not within a predetermined range suitable for the transmission of speech packets through the network using the reduced maximum speech coding rate, the Codec Mode Request is further reduced as a function of the operational parameters and then forwarded toward the distant terminal. The Encoder within this distant terminal (distant for the Codec Mode Request) does then use the received Codec Mode Request to determine the codec mode for the next speech frames it wants to send towards the other mobile station.

In one case, the distant terminal is a MS and the immediately preceding intermediate network node is a Radio Network Controller (RNC). In such cases, the RNC can estimate the uplink radio quality between the distant MS and the RNC and further reduce the speech coding rate as a function of the uplink radio quality if it is not within a predetermined range suitable for the transmission of speech packets (as described above for prior art).

The foregoing has outlined, rather broadly, the principles of the present invention so that those skilled in the art may better understand the detailed description of the exemplary embodiments that follow. Those skilled in the art should appreciate that they can readily use the disclosed conception and exemplary embodiments as a basis for designing or modifying other structures and methods for carrying out the same purposes of the present invention. Those skilled in the art should also realize that such equivalent constructions do not depart from the spirit and scope of the invention in its broadest form, as defined by the claims provided hereinafter.

### BRIEF DESCRIPTION OF THE DRAWINGS

FIG. 1 illustrates a conventional VoIP implementation;

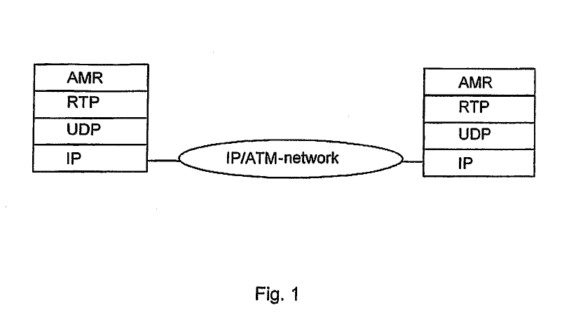

FIG. 2 illustrates the use of DCCP and ECN;

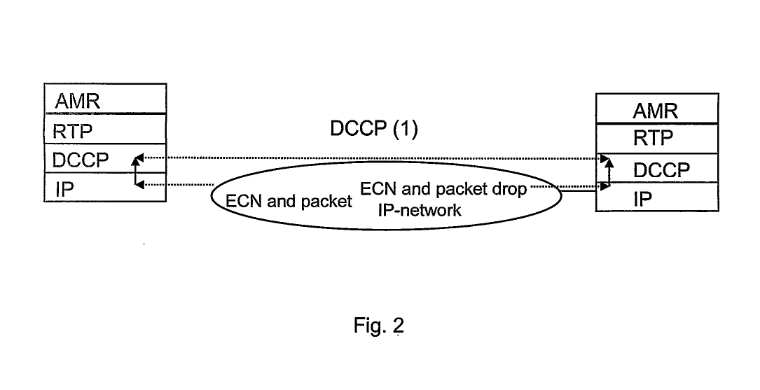

FIGS. 3a and 3b illustrate the state-of-the-art in GSM and UMTS cellular networks, respectively;

FIGS. 4a and 4b illustrate the principles of the invention within GSM and UMTS networks; respectively;

FIG. 5 illustrates the basis topology of a network in which the principles of the invention can be used to advantage;

FIG. 6 illustrates a flowchart of an exemplary method for managing coder/decoder (codec) rate adaptation for a wireless circuit-switched voice call routed through a packet-based network;

FIG. 7 illustrates a flowchart of an exemplary method for managing coder/decoder (codec) rate adaptation as a function of air-interface quality;

FIG. 8 illustrates a first example of the principles of the invention in operation;

FIG. 9 illustrates a second example of the principles of the invention in operation; and,

FIG. 10 illustrates a third example of the principles of the invention in operation.

### DETAILED DESCRIPTION

A key factor in the Rate Control as described above lays in the fact that only one encoder is used and one decoder on the whole path, end-to-end. The Rate Control takes care that the selected rate fits to all links on the path. This principle idea is now in the proposed solution combined with IP congestion handling. The solution is to combine the air-interface adaptability and adaptability in the IP-network as described above. One scenario is for VoIP over packet-core network (GPRS with IP-backbone in GSM/WCDMA); another is related to circuit-switched traffic over an IP-backbone.

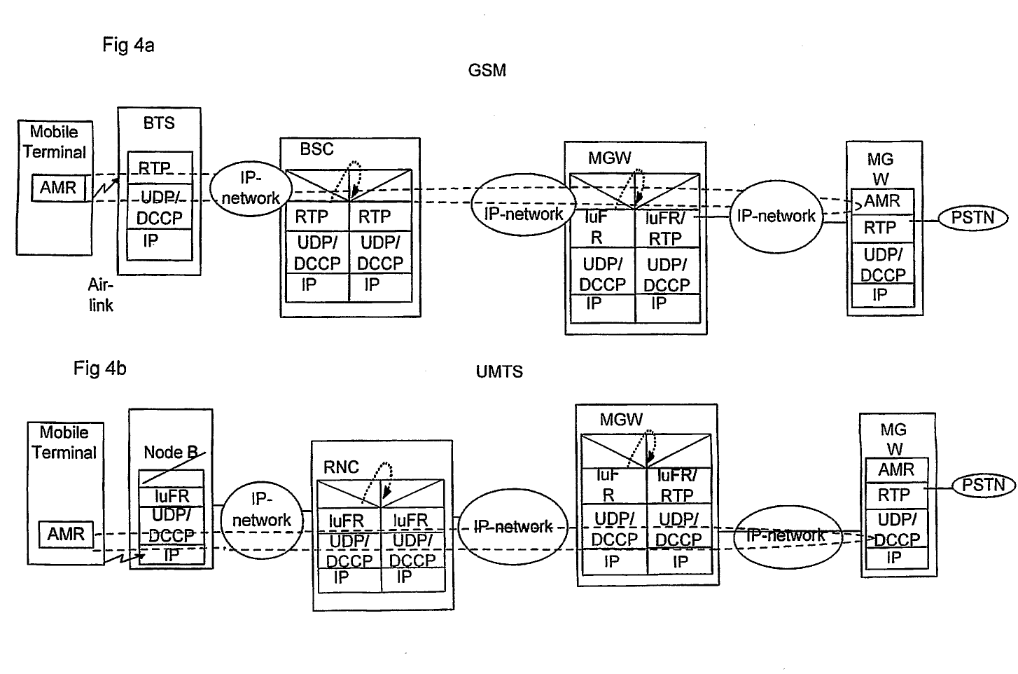

FIGS. 4a and 4b illustrate the principles of the invention within GSM and UMTS networks, respectively, in which rate-adaptation is made both to radio and to conditions in the IP-transport networks. The rate adaptation is made according to the available resources both in radio and a number of intermediate IP-networks. The interaction can be described as follows:
1) Two mobile stations, preferably CS terminals (Circuit Switched terminal), are sending speech frames to each other. Another example is a mobile station and a MGW communicating in a UE-to-PSTN call.
2) The first mobile station is sending a compressed voice frame in forward direction, including rate-commands (CMR) for the opposite direction; i.e. for the receiving speech frames.
3) The BTS/node-B and/or BSC/RNC are modifying potentially the speech rate commands according to radio conditions in backward (opposite) direction.
4) The MGW and RNC are measuring the number of ECN-marked or dropped packets on the backward links (Nb and Iu) and are adjusting the DCCP sending rate and rate-commands (CMR) according to network conditions.

The IP-network can be the same or different depending on the topology and configuration of the transport networks. The adaptation in radio is made according to the previous described methods. The adaptation according to IP-network conditions is also made according to the previous described methods by use of ECN or Diff.serv remarking, DCCP and detection of dropped packets or other methods. The algorithm for DCCP should ideally be adapted to the speech-codec and its configuration.

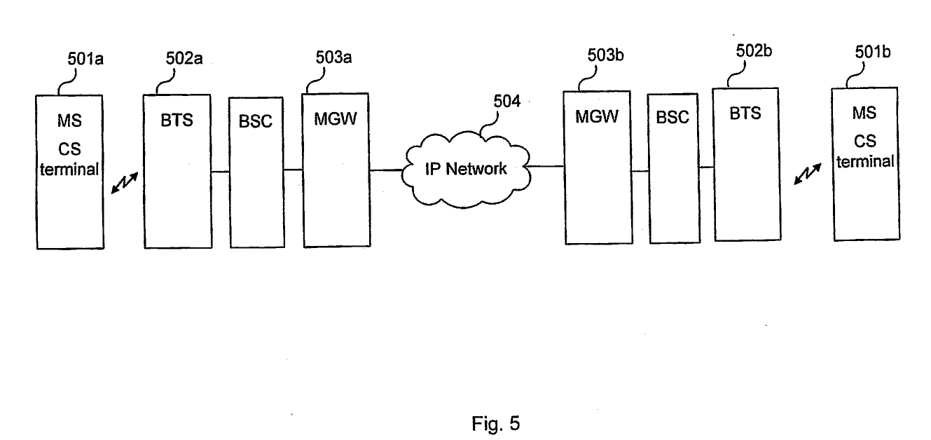

For the purpose of further describing the operative principles of the invention, FIG. 5 illustrates the topology of a basic network in which the principles of the invention can be used to advantage. A Mobile Station (MS) 501a, using circuit-switched voice communications means, is used for voice communications with a second Mobile Station; the second Mobile Station can be a wireline terminal or, as illustrated, another MS 501b. MSs 501a and 501b communicate wirelessly with the network through Base Transceiver Stations (BTS) 502a and 502b, respectively. Media Gateways 503a and 503b then provide the means to route the voice communication through a packet-based network, such as an Internet Protocol (IP) network 504. The Quality of Service (QoS) for such voice communications can be negatively impacted by degradation of the air interface, for example, between MS 501a and BTS 502a, as well as by congestion in the IP network 504. These problems, however, can be overcome using the principles of the present invention.

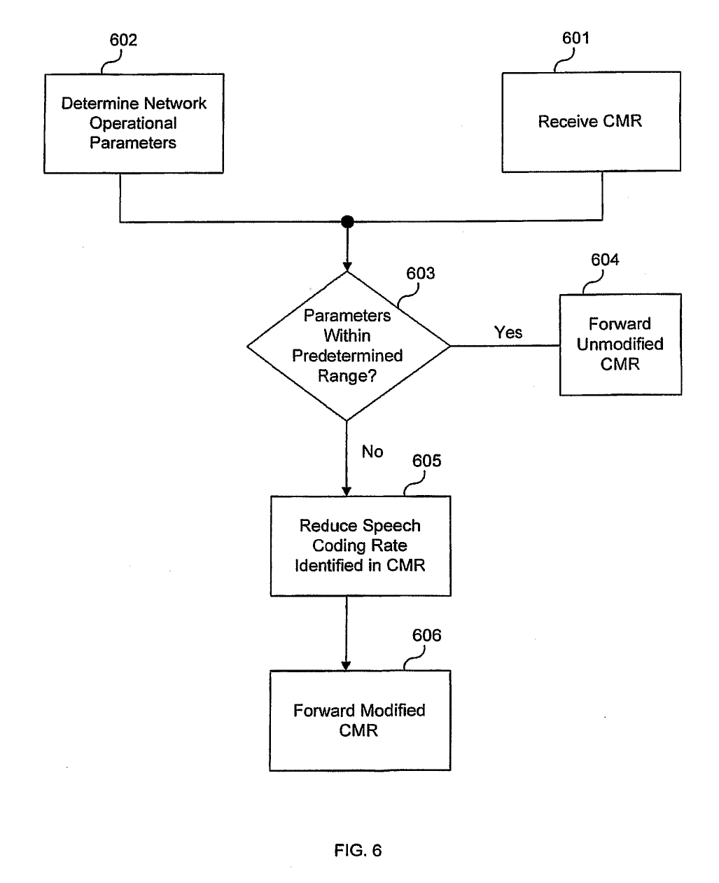

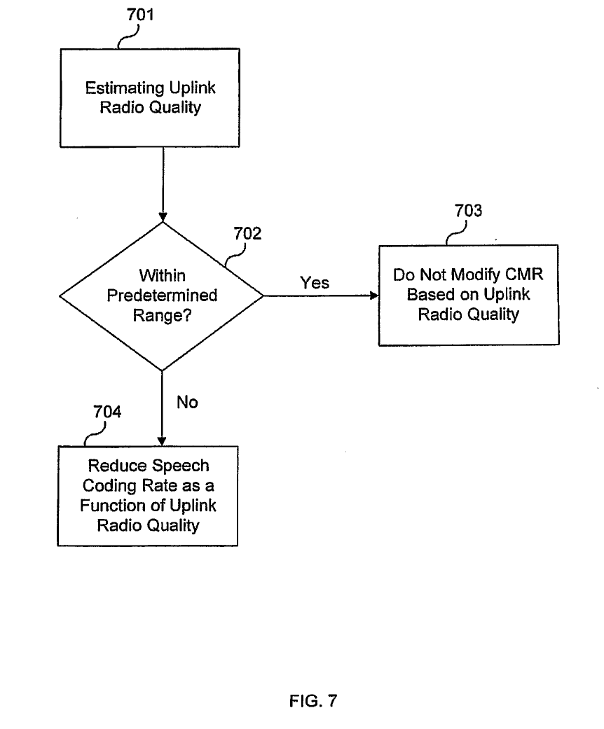

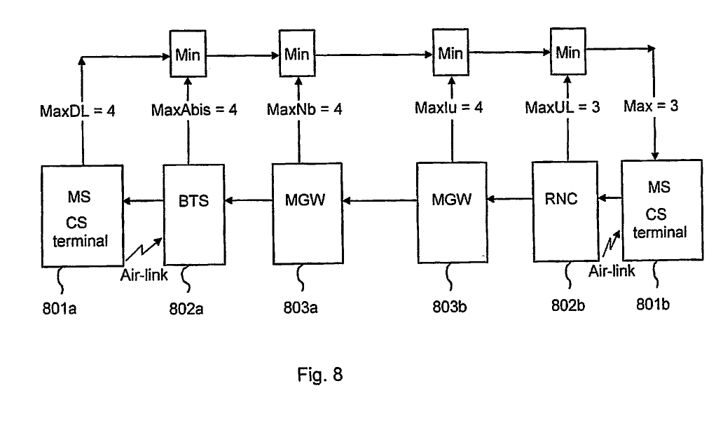

The invention combines mechanisms to adapt the speech coding rate of a MS as a function of network congestion at any link in the packet-based core network, as well as the air-interface quality. The methods used to adapt the speech coding rate are generally illustrated in FIGS. 6 and 7; specific examples of the operation of the method are illustrated in FIGS. 8-10, described infra. As illustrated in FIG. 6, with continuing reference to FIG. 5, a network node receives a CMR in Step 601. An initial CMR is set by the MS 501a and identifies an initial maximum speech coding rate selected as a function of downlink radio quality between BTS 502a and the MS 501a receiver. Subsequently, the CMR is received, for example, by MGW 503a and MGW 503b, along with speech packets from MS 501a. In Step 602, which can be performed on a continual basis, a network node (e.g., MGW 503a) monitors and determines network operational parameters, such as congestion in IP Network 504. The protocol described in Internet Engineering Task Force (IETF) Request for Comments (RFC) 3168, “The Addition of Explicit Congestion Notification (ECN) to IP” (September 2001), incorporated herein by reference, can be utilized to signal such network congestion; the ECN protocol can, for example, measure congestion in the IP Network 504 based on speech packets transmitted by the distant terminal (e.g., MS 501b) to MS 501a.

In Step 603, it is determined whether the parameters are within a predetermined range. If so, the speech packets are forwarded with an unmodified CMR (Step 604); otherwise, the speech coding rate identified in the CMR is reduced as a function of the measured network parameters (Step 605) and the speech packets are forwarded with the modified CMR (Step 606). The CMR can be further modified at subsequent network nodes. In such cases, one or more operational parameters of the packet-based network are determined at such subsequent network node using for example the ECN protocol. When the modified CMR is received at the subsequent network node, it is forwarded toward the distant terminal if the operational parameters are within a predetermined range suitable for the transmission of speech packets through the network using the reduced maximum speech coding rate; otherwise, the reduced maximum speech coding rate identified in the Codec Mode Request is further reduced as a function of the operational parameters and then forwarded toward the distant terminal.

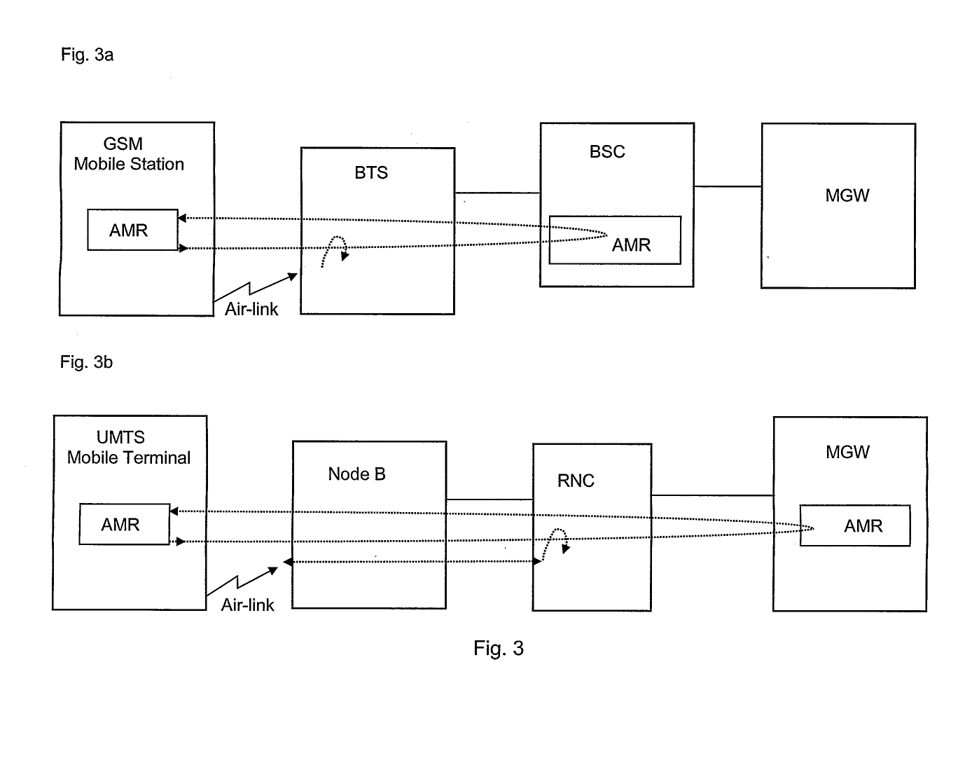

In cases where the distant terminal is another MS (e.g., MS 501b), the CMR can be further modified as a function of the uplink radio quality to the distant MS. For example, as illustrated in FIG. 3, a Radio Network Controller (RNC) can estimate the uplink radio quality (Step 701) for the second MS. If the uplink radio quality is within a predetermined range (Step 702) suitable for the transmission of the speech packets, the RNC does not modify the CMR (Step 703); if the uplink radio quality is not within the predetermined range, however, the RNC will further reduce the speech coding rate as a function of the uplink radio quality (Step 704). Thus, the optimum CMR can be determined on an end-to-end basis as a function of air interface quality and network congestion.

Turning now to FIGS. 8-10, illustrated are examples of the principles of the invention in operation. In these examples, there are four speech coding modes, Modes 1 through 4, corresponding respectively to 4.75, 5.90, 7.40 and 12.20 kb/s. First, FIG. 8 illustrates an example in which there is a deficiency in the uplink to distant MS 801b. Initially, MS 801a estimates the downlink radio quality between BTS 802a and its receiver. In this example, the quality is very good and, therefore, MS 801a requests to use Mode 4 for the DownLink (MaxDL=4); i.e., the CMR corresponds to Mode 4. In this example, it is assumed that BTS 802a determines that the Abis interface (Interface between BTS and MGW) is not overloaded and that the speech coding rate should correspond to Mode 4 (i.e., MaxAbis=4); if BTS 802a determined, for example, that the Abis interface is currently overloaded, however, it could limit the rate (e.g., set MaxAbis=3). Thus, MS 801a uses an initial speech coding rate of 12.20 kb/s for speech packets (or frames), and the BTS 802a sets the CMR, otherwise referred to as a Codec Mode Command (CMC), as the minimum (“Min”) of MaxDL and MaxAbis (i.e., Mode 4), which is then forwarded with the speech packets to MGW 803a. In this example, MGW 803a also determines that there is no network congestion on the Nb interface (Interface between MGWs) warranting a reduced speech coding rate (i.e., MaxNb=4), as indicated by ECN, and, thus, CMR Mode 4 is maintained. Similarly, MGW 803b determines that there is no network congestion on the Iu interface (Interface between MGW and RNC) warranting a reduced speech coding rate (i.e., MaxIu=4), as indicated by ECN, and, thus, CMR Mode 4 is again maintained. Radio Network Controller 802b, however, determines that there is an overload on the UpLink from MS 801b that warrants a decrease in the speech coding rate; in this example, the overload requires a reduction to Mode 3 (MaxUL=3) and, thus, RNC 802b sets the CMR to the minimum of the received CMR and MaxUL, which is then forwarded with the speech packets to MS 801b. MS 801b then sets its speech coding rate to 7.40 kb/s. This speech coding rate is identified by a Codec Mode Indication (CMI) parameter in each speech frame transmitted from MS 801b to MS 801a; upon receipt of such a speech frame, MS 801a then sets its speech coding rate to Mode 3. Thus, in this example, codec rate adaptation that accounts for both air-interface quality and network congestion on an end-to-end basis is accomplished within one round-trip time period.

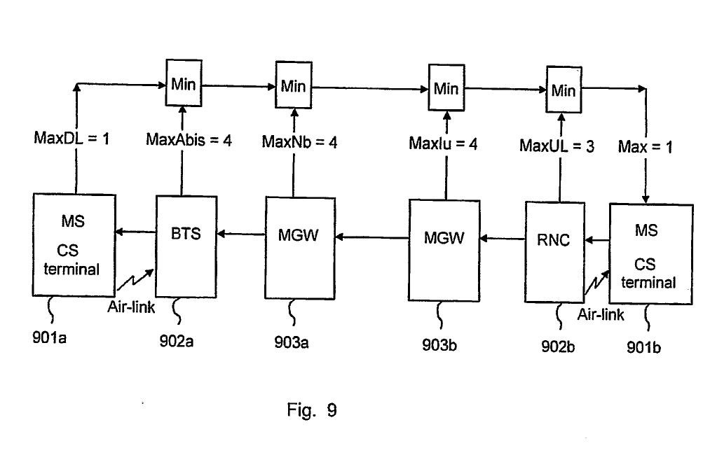

FIG. 9 illustrates an example in which there is a deficiency in the downlink to MS 901a. Initially, MS 901a estimates the downlink radio quality between BTS 902a and its receiver. In this example, the quality is poor and MS 901a requests to use Mode 1 for the downlink (MaxDL=1); i.e., the CMR corresponds to Mode 1. In this example, it is assumed that BTS 902a determines that the Abis interface is not currently overloaded and that the speech coding rate should correspond to Mode 4 (i.e., MaxAbis=4). Thus, MS 901a uses an initial speech coding rate of 4.75 kb/s for speech packets (or frames), and the BTS 902a sets the CMR, otherwise referred to as a Codec Mode Command (CMC), as the minimum (“Min”) of MaxDL (i.e., Mode 1) and MaxAbis (i.e., Mode 4), which is then forwarded with the speech packets to MGW 903a. In this example, MGW 903a also determines that there is no network congestion on the Nb interface warranting a reduced speech coding rate (i.e., MaxNb=4), as indicated by the ECN protocol. MGW 903a, however, sets the CMR to the minimum of the CMR (i.e., Mode 1) received from BTS 902a and MaxNb (Mode 4); thus, MGW 903a forwards the speech packets with an indicated CMR of Mode 1. Similarly, MGW 903b determines that there is no network congestion on the Iu interface warranting a reduced speech coding rate (i.e., MaxIu=4). MGW 903b, however, sets the CMR to the minimum of the CMR (i.e., Mode 1) received from MGW 903a and MaxIu (i.e., Mode 4); thus, MGW 903b forwards the speech packets with an indicated CMR of Mode 1. Radio Network Controller 902b determines that there is an overload on the uplink from MS 901b that warrants a decrease in the speech coding rate; in this example, the overload requires a reduction to Mode 3 (MaxUL=3). RNC 902b sets the CMR to the minimum of the received CMR (i.e., Mode 1) and MaxUL (i.e., Mode 3), which is then forwarded with the speech packets to MS 901b. MS 901b then sets its speech coding rate to 4.75 kb/s. Thus, in this example, codec rate adaptation that accounts for both air-interface quality and network congestion on an end-to-end basis is accomplished within one one-way time period.

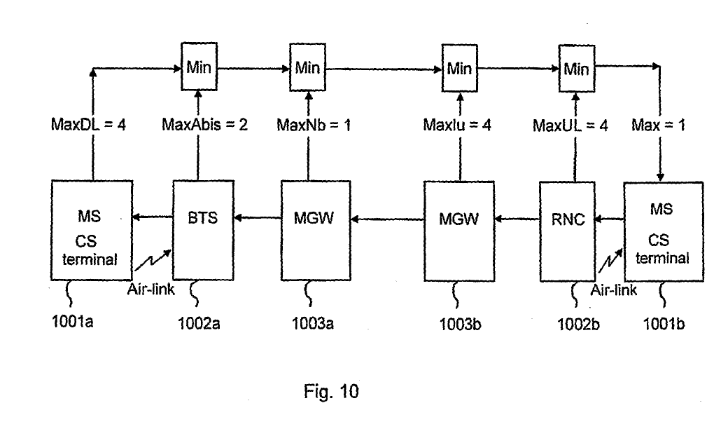

Finally, FIG. 10 illustrates an example in which there are deficiencies in both the air-interface and core network. Initially, MS 1001a estimates the downlink radio quality between BTS 1002a and its receiver. In this example, the quality is very good and, therefore, MS 1001a requests to use Mode 4 for the downlink (MaxDL=4); i.e., the CMR corresponds to Mode 4. In this example, BTS 1002a determines that the Abis interface is currently overloaded and that the speech coding rate should correspond to Mode 2 (i.e., MaxAbis=2). Speech coding rate of 5.90 kb/s for speech packets (or frames) is used, and the BTS 1002a sets the CMR, as the minimum (“Min”) of MaxDL (i.e., Mode 4) and MaxAbis (i.e., Mode 2), which is then forwarded with the speech packets to MGW 1003a. In this example, MGW 1003a determines that there is network congestion on the Nb interface warranting a reduced speech coding rate (i.e., MaxNb=1). Thus, MGW 1003a sets the CMR to the minimum of the received CMR (i.e., Mode 1) and MaxNb (i.e., Mode 1), which is then forwarded with the speech frames to MGW 1003b. MGW 1003b determines that there is no network congestion on the Iu interface warranting a reduced speech coding rate (i.e., MaxIu=4); thus, MGW 1003b sets the CMR to the minimum of the received CMR (i.e., Mode 1) and MaxIu (i.e., Mode 4), which is then forwarded with the speech frames to RNC 1002b. Radio Network Controller 1002b determines that there is no overload on the uplink from MS 1001b that warrants a decrease in the speech coding rate and, thus, RNC 1002b sets the CMR to the minimum of the received CMR (i.e., Mode 1) and MaxUL (i.e., Mode 4), which is then forwarded with the speech packets to MS 1001b. MS 1001b then sets its speech coding rate to 4.75 kb/s. This speech coding rate is then identified by a Codec Mode Indication (CMI) parameter in each speech frame transmitted from MS 1001b to MS 1001a. Thus, in this example, codec rate adaptation that accounts for both air-interface quality and network congestion on an end-to-end basis is accomplished within one one-way time period.

Finally, it is considered how to select the optimal AMR mode. As one example, the AMR may be configured with the most preferred configuration of four modes with 12.2, 7.4, 5.9 and 4.75 kbits/s. These rates are reasonable for the individual radio link in GSM for full rate traffic channels and half rate traffic channels (where the 12.2 is not possible and excluded). Typically, the radio links are most of the time good to excellent and so most calls have rates of 12.2 and only some run at lower rates. The average bit rate may be in the order of, for example, 80%*12.2+10%*7.4+5%*5.9+5%*4.75=11 kbit/s; slightly simplified. Now there are, in this example, thousands of calls passing the Nb-link between two MGWs. All of these are varying in bit rate all the time due to the individual radio conditions, but the Nb-link is not overloaded and does not change the flowing Rate Control Commands. But then—due to increased traffic during a coming peak hour—the Nb-link reaches its limit of capacity and starts to control the rates downwards. But how to do it best? A first option is to lower the rate for all calls from max 12.2 to max 7.4. But this is already a big step and limits the call quality for nearly all calls and gains much more capacity on Nb than actually needed. So this is not optimal. The average bit rate would then be (same radio conditions assumed): 80%*7.4+10%*7.4+5%*5.9+5%*4.75=7.2 kbit/s. The increase in capacity on Nb would be 11/7.2=1.5=50%., which is too much (i.e., more than needed for a just threatening overload). A second option is for the Nb-link to limit the rates only for some voice calls (e.g. 10%) and leave others unaffected. This is much better, because 90% of the callers perceive still the optimal quality. But now some have uncompromised quality all the time while others have a lower quality permanently. The capacity gain in this example: 11/(90%*11+10%*7.2)=1.04=4% more, so we can control the overload in small steps. Finally, a third and best option is to limit at one point in time the rates for some of the voice calls and then at a next point in time it imposes the rate restriction to other calls and then to again other calls and so it “distributes” the rate restriction over all calls, but only to a smaller extent. For example, on average each rate is lowered from 11 kbit/s to 10.6 kbit/s, although of curse this bit rate does not exist as real rate, but only as long term average. In this case, the perceived voice quality is to a large extent much closer to the 12.2 than the 7.4 and that is what we want: quality as good as possible, restricted only as much as necessary.

The described rate control works quite fast. The AMR standard allows to go up/down with the rate by one step (e.g. 12.2 to 7.4) in 40 ms. To go from top rate 12.2 to bottom rate 4.75 takes 3*40=120 ms. The rate control command loop takes basically one round trip delay at maximum, which is typically lower than 400 ms. So both together allow a coarse estimate on the rate control speed; e.g., within (worst case) 500 ms the capacity on the Nb-Link can be increased by a factor 12.2/4.75=2.5=250%. Unfortunately, these calculations are based on the net bit rates and ignore the packet overhead, so they work much better for ATM than for IP.

Although the present invention has been described in detail, those skilled in the art will conceive of various changes, substitutions and alterations to the exemplary embodiments described herein without departing from the spirit and scope of the invention in its broadest form. The exemplary embodiments presented herein illustrate the principles of the invention and are not intended to be exhaustive or to limit the invention to the form disclosed; it is intended that the scope of the invention be defined by the claims appended hereto, and their equivalents.

### Abbreviations/Definitions

| | |
|---|---|
| Abis | Interface between BTS and MGW |
| AMR | Adaptive Multi-Rate |
| ATM | Asynchronous Transfer Mode |
| BSC | Base Station Controller |
| BTS | Base Transceiver Station |
| CMC | Codec Mode Commands |
| CMI | Codec Mode Indications |
| CMR | Codec Mode Requests |
| CRCR | Codec Rate Control Request |
| CS terminal | Circuit Switched Terminal |
| DCCP | Datagram Congestion Control Protocol |
| DL | Downlink interface at MS |
| ECN | Explicit Congestion Notification |
| GSM | Global System for Mobile Communications |
| IETF | Internet Engineering Task Force |
| IP | Internet Protocol |
| Iu | Interface between MGW and RNC |
| MGW | Media Gateway |
| MGW | Media Gateway |
| MS | Mobile Station |
| Nb | Interface between MGWs |
| PSTN | Public Switched Telephone Network |
| QoS | Quality of Service |
| RNC | Radio Network Controller |
| RNC | Radio Network Controller |
| TCP | Transport Control Protocol |
| UDP | User Datagram Protocol |
| UE | User Equipment |
| UL | Uplink interface at MS |
| UMTS | Universal Mobile Telecommunications Systems |
| VoIP | Voice Over IP |

1. A method in a network for managing coder/decoder (codec) rate adaptation for a wireless circuit-switched voice communication routed through a packet-based network, wherein a Mobile Station (MS) participating in that voice communication with a distant node/terminal transmits an initial Codec Mode Request (CMR) identifying an initial maximum speech coding rate, said CMR selected by said MS as a function of a downlink radio quality estimated by said MS, said method comprising the steps of:
determining, at a network node intermediate to said MS and said distant terminal, one or more operational parameters of said packet-based network by measuring characteristics of said packet-based network using Explicit Congestion Notification (ECN) protocol;
receiving said CMR at said intermediate network node; and,
if said one or more operational parameters are not within a predetermined range suitable for the transmission of speech packets through said packet-switched network using said initial maximum speech coding rate request, reducing the maximum speech coding rate identified in said CMR as a function of said one or more operational parameters and forwarding said modified CMR toward said distant terminal.

2. The method recited in claim 1, further comprising the steps of:
determining, at a second network node intermediate to said MS and said distant terminal, one or more operational parameters of said packet-based network using said ECN protocol:
receiving said modified CMR at said second network node; and,
if said one or more operational parameters are not within said predetermined range suitable for the transmission of speech packets through said packet-switched network using said reduced maximum speech coding rate, further reducing the maximum speech coding rate identified in said CMR as a function of said one or more operational parameters and forwarding said further modified CMR toward said distant terminal.

3. The method recited in claim 1, wherein said ECN protocol indicates congestion in said packet-based network based on measurement of speech packets transmitted by said distant terminal to said MS.

4. The method recited in claim 1, wherein said distant terminal comprises a second Mobile Station (MS).

5. The method recited in claim 4, wherein said network node comprises a Radio Network Controller (RNC).

6. The method recited in claim 5, further comprising the steps of:
estimating, by said RNC, the uplink radio quality between said second MS and said RNC; and
further reducing said maximum speech coding rate by said RNC as a function of said uplink radio quality if it is not within a predetermined range suitable for the transmission of speech packets.

7. A system for managing coder/decoder (codec) rate adaptation for a wireless circuit-switched voice communication routed through a packet-based network, wherein a Mobile Station (MS) participating in that voice communication with a distant terminal transmits an initial Codec Mode Request (CMR) identifying an initial maximum speech coding rate, said CMR selected by said MS as a function of a downlink radio quality estimated by said MS, said system comprising:
means for determining, at a network node intermediate to said MS and said distant terminal, one or more operational parameters of said packet-based network by measuring characteristics of said packet-based network using Explicit Congestion Notification (ECN) protocol;
means for receiving said CMR at said network node; and,
means for selectively altering and forwarding said Codec Rate Control Request, wherein if said one or more operational parameters are not within a predetermined range suitable for the transmission of speech packets through said packet-switched network using said initial maximum speech coding rate, reducing the maximum speech coding rate identified in said CMR as a function of said one or more operational parameters and forwarding said modified Coded Rate Control Request toward said distant terminal.

8. The system recited in claim 7, further comprising:
means for determining, at a second network node intermediate to said MS and said distant terminal, one or more operational parameters of said packet-based network using said ECN protocol:
means for receiving said modified CMR at said second network node: and,
means for selectively altering and forwarding said CMR by said second network node, wherein if said one or more operational parameters are not within said predetermined range suitable for the transmission of speech packets through said packet-switched network using said reduced maximum speech coding rate, further reducing the maximum speech coding rate identified in said CMR as a function of said one or more operational parameters and forwarding said further modified CMR toward said distant terminal.

9. The system recited in claim 7, wherein said ECN protocol indicates congestion in said packet-based network based on measurement of speech packets transmitted by said distant terminal to said mobile station.

10. The system recited in claim 7, wherein said distant terminal comprises a second Mobile Station (MS).

11. The system recited in claim 10, wherein said network node comprises a Radio Network Controller (RNC).

12. The system recited in claim 11, further comprising:
means for estimating, by said RNC, the uplink radio quality between said second MS and said RNC; and.
means for further reducing said maximum speech coding rate by said RNC as a function of said uplink radio quality if it is not within a predetermined range suitable for the transmission of speech packets.

13. A network node for managing coder/decoder (codec) rate adaptation for a wireless circuit-switched voice communication routed through a packet-based network, wherein an initial Codec Mode Request (CMR) identifying an initial maximum speech coding rate selected by a Mobile Station (MS) participating in that voice communication with a distant terminal and received by said network node, said network node located intermediate to said MS and said distant terminal and comprising:
computer system hardware: and,
software operative, in combination with said computer system hardware, to:
determine one or more operational parameters of said packet-based network by measuring characteristics of said packet-based network using Explicit Congestion Notification (ECN) protocol;
receive said Codec Rate Control Request; and,
if said one or more operational parameters are not within a predetermined range suitable for the transmission of speech packets through said packet-switched network using said initial maximum speech coding rate, reduce the maximum speech coding rate identified in said CMR as a function of said one or more operational parameters and forward said modified CMR toward said distant terminal.

14. The network node recited in claim 13, wherein said ECN protocol measures congestion in said packet-based network based on speech packets transmitted by said distant terminal to said MS.

15. The network node recited in claim 13, wherein said network node comprises a Radio Network Controller (RNC).

16. The network node recited in claim 15, wherein said distant terminal comprises a second Mobile Station (MS) and wherein said computer system hardware and software are further operative, in combination, to:
estimate the uplink radio quality between said second MS and said RNC; and, reduce said initial maximum speech coding rate as a function of said uplink radio quality if it is not within a predetermined range suitable for the transmission of speech packets through said packet-switched network.

17. The network node recited in claim 13, wherein the network node is a first network node, and wherein the max coding rate indicated by said CMR is reduced by the first network node prior to the reception by a second network node of said CMR.
